(19) United States
(12) Patent Application Publication
(10) Pub. No.: US 2016/0110054 A1
(43) Pub. Date: Apr. 21, 2016

(54) SYSTEM AND METHOD FOR CUSTOMIZING A THEME FOR MODIFYING A LOOK AND FEEL OF A GRAPHICAL USER INTERFACE

(71) Applicant: Cyanogen Inc., Palo Alto, CA (US)

(72) Inventors: Steve Kondik, Kent, WA (US); Asher Isaac Simonds, Seattle, WA (US); Dave Herman, Seattle, WA (US); Clark Scheff, Seattle, WA (US); Andy Mast, Issaquah, WA (US)

(21) Appl. No.: 14/519,156

(22) Filed: Oct. 21, 2014

(51) Int. Cl. G06F 3/0481; G06F 17/24; G06F 3/0484

(52) U.S. Cl. CPC G06F 3/04812; G06F 3/04847; G06F 17/248

(57) ABSTRACT

A method and system for enabling a user to customize a theme for modifying a graphical user interface (GUI). The GUI comprises components that are customizable. These include icons, fonts, colors, images, etc. Themes comprise GUI elements, and a GUI element of a theme is associated with a component of a GUI. GUI elements comprise icons, colors, wallpapers, notification sounds, ringtones, etc., which are applied to components of a GUI when a theme is applied to the GUI. The system generates a theme preview for a theme, which comprises a representation of the theme applied to components of a GUI. A user can customize a theme by selecting, via an interface generated by the system, a component of a GUI, and identifying an alternate GUI element to be associated with the component in the theme.

### BACKGROUND

Most computing devices generate visually appealing graphical user interfaces. Designers select fonts, colors, icons, and images, and similar elements, with the goal that a graphical user interface be both functional and aesthetically pleasing. However, what is beautiful to one user may be ugly to another. Designers can alleviate a user's distaste by enabling the user to customize a graphical user interface.

Some devices permit users to change the appearance of a graphical user interface in minute ways. For instance, some merely provide a choice of wallpaper or color scheme for an interface. Some graphical user interfaces can be modified by “themes,” which are packages comprising specific graphical appearance details for an application or operating system. Themes can also include sounds that replace default sounds of an application or operating system. A user can apply a theme to change the look and feel of an application or operating system.

A device can caution a user of the changes that applying a theme will bring to a graphical user interface. A device can display a preview of a theme, including a pre-drawn representation of the theme. However, although a user can preview elements of a theme, the user cannot easily customize the theme itself.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a suitable environment in which a system for customizing a theme may operate.

FIG. 2 is a block diagram of a system for customizing a theme.

FIG. 3 is a flow diagram depicting a method, performed by a system for customizing a theme, for receiving modifications to a theme by a user and applying the modified theme to a graphical user interface.

FIG. 4 is a diagram of a mobile device showing a representative graphical user interface modified by a theme.

FIG. 5 is a screenshot of a representative interface showing a theme preview for a theme.

FIGS. 6A and 6B are screenshots of interfaces showing components of a graphical user interface including associated GUI elements of a theme.

FIG. 7 is a screenshot of a representative interface showing a theme preview for a customized theme.

### DETAILED DESCRIPTION

A method and system are described for enabling a user to customize a theme for modifying a look and feel of a graphical user interface (GUI). The GUI comprises components that are customizable. These include icons, fonts, colors, images, sounds, and so forth. Themes comprise GUI elements, and a GUI element of a theme is associated with a component of a GUI. GUI elements comprise icons, colors, wallpapers, notification sounds, ringtones, and so forth. A GUI element is applied to a component of a GUI for changing a look and feel of the GUI when a theme that the GUI element belongs to is applied to the GUI. The system generates a theme preview for a theme, which comprises a preview image showing a representation of the theme applied to a GUI. A user can customize a theme by selecting, via an interface generated by the system, a component of a GUI, and identifying an alternate GUI element to be associated with the component in the theme. In some implementations, the alternate GUI element is selected from among GUI elements associated with the component in other themes.

The system generates a theme preview by applying GUI elements of a theme to an arrangement for components of a GUI. In some implementations, an arrangement and selection of components for a theme preview are specified by a theme preview template. For example, a theme preview template may identify components and a generic layout for a theme preview. In generating the theme preview, the system can apply GUI elements of a theme to the theme preview template, producing a theme preview that conveys how the theme may change the look and feel of a GUI. When a theme is ultimately applied to the GUI, GUI elements of the theme are applied to respective components of the GUI with which they are associated.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of a system for generating a theme preview for a theme and enabling a user to customize the theme prior to applying the theme to a GUI of an operating system or application. The systems are described with respect to a number of processes that they may implement and numerous examples of how they may be implemented.

### Suitable Environments

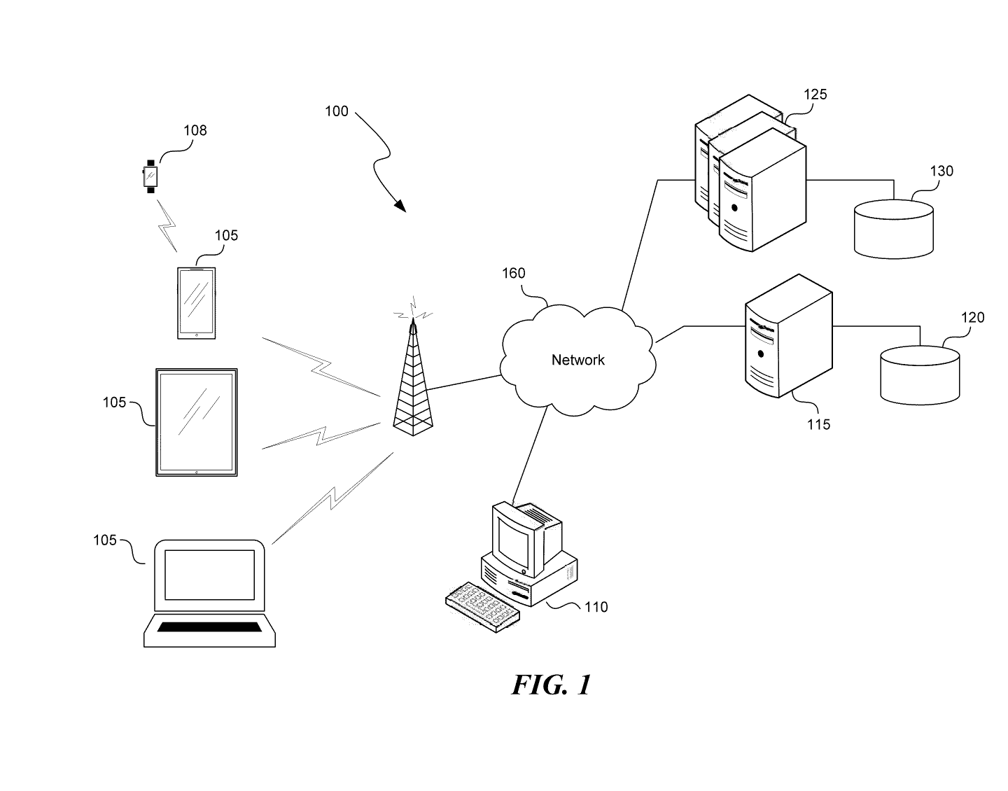

FIG. 1 and the following discussion provide a brief, general description of a suitable computing environment 100 in which a system for customizing a theme can be implemented. Although not required, aspects and implementations of the invention will be described in the general context of computer-executable instructions, such as routines executed by a general-purpose computer, a personal computer, a mobile device, a server, or other computing systems. The invention can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network 160, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a system for customizing a theme according to embodiments of the invention operates in or among mobile devices 105, wearable devices 108, personal computers 110, and one or more server computers 115. The mobile devices 105, wearable devices 108, and personal computers 110 communicate through one or more wired or wireless networks 160 with the server 115. A data storage area 120 contains data utilized by the system, and, in some implementations, software necessary to perform functions of the system. For example, the data storage area 120 may contain GUI data, such as data describing components of a GUI, theme data, and so forth. Devices 105, 108, 110 can store customized themes in the data storage area 120. The system for customizing a theme communicates via public or private networks with one or more third party servers 125 storing data in data storage area 130. The third party servers include servers maintained by entities that host third party themes.

The mobile devices 105 and computers 110 communicate with each other and the server 115 and third party servers 125 through networks 160, including, for example, the Internet. The mobile devices 105 communicates wirelessly with a base station or access point using a wireless mobile telephone standard, such as the Global System for Mobile Communications (GSM), or another wireless standard, such as IEEE 802.11, and the base station or access point communicates with the server 115 via the networks 160. Computers 110 communicate through the networks 160 using, for example, TCP/IP protocols. The wearable devices 108 communicate via short range communication protocols (e.g., Bluetooth) with the mobile devices 105 and/or computers 110. In some implementations, the system enables a user to customize a theme using a first device, and the system applies the customized theme to a GUI generated by another device.

### Suitable Systems

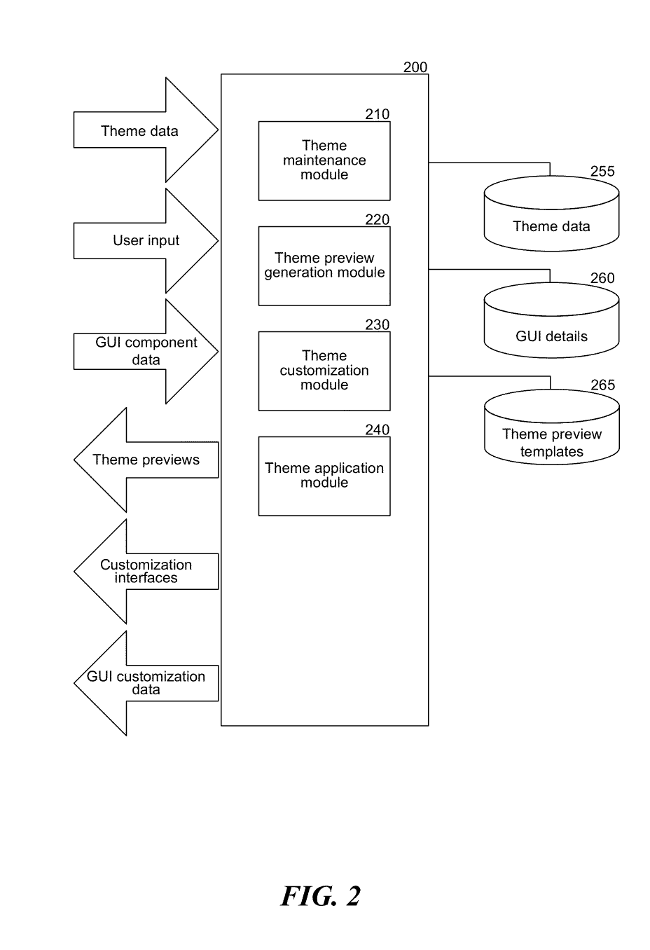

FIG. 2 is a block diagram of a system 200 for customizing a theme that can be applied to a GUI, modifying a look and feel of the GUI. The system can operate in, for example, mobile devices 105, wearable device 108, and/or computers 110, or distributed among at least one device and server 115. The system 200 includes a theme maintenance module 210, a theme preview generation module 220, a theme customization module 230, and a theme application module 240. The system receives theme data, user input, and GUI component data, and outputs theme previews, customization interfaces, and GUI customization data. The system stores data in and reads data from theme data storage 255, GUI details data storage 260, and theme preview templates data storage 265.

The theme maintenance module 210 maintains theme data in theme data storage area 255. Theme data includes themes, customized themes, GUI elements, and data associated with themes or GUI elements, such as metadata associated with alternate GUI elements linking those alternate GUI elements with components of a GUI. Themes are packages of GUI elements. GUI elements include icons, fonts, colors, images, wallpapers, controls, ringtones, boot animations, notification sounds, etc. A GUI element of a theme is applied to a component of a GUI when the theme is applied to the GUI. Alternate GUI elements include GUI elements that are not part of a theme, and those that are part of a theme that is different from a theme being customized by a user. Components of a GUI include icons, fonts, colors, wallpapers, etc. of a GUI, which can be modified by a theme. A component can include sub-components. For example, an icons component may include sub-components for individual icons. The system can treat sub-components as it does components. For example, a GUI element of a theme can be associated with a sub-component of a GUI, and the GUI element can be applied to the sub-component in a theme preview. A theme preview for a theme includes GUI elements of the theme applied to components of a GUI arranged in a manner representing a look and feel of the GUI if the theme were applied to the GUI.

Theme data is stored in theme data storage 255. In some implementations, theme data is received from third parties. For example, the system may receive themes and alternate GUI elements from theme publishers. Theme data can also be created by a user of a device whose GUI is customized by the system, or by other users. For example, theme data may include a customized theme. In some implementations, theme data stored in theme data storage 255 includes themes of a theme store, and the themes can be purchased by a user. In some implementations, theme data includes settings and configuration details for a GUI generated by a device. For example, theme data may include a theme that has already been applied to a GUI for an operating system.

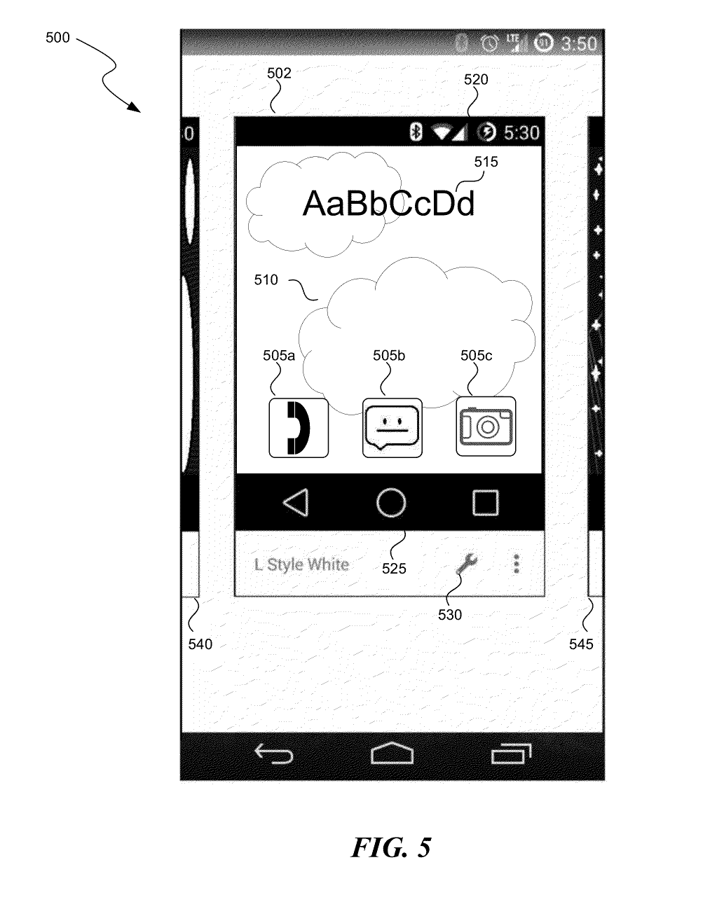

The theme preview generation module 220 generates theme previews. A theme preview comprises a preview image of a representative GUI showing GUI elements of a theme applied to components of the GUI. FIG. 5 shows a representative screenshot including a theme preview. In some implementations, a theme preview includes sounds, videos, or animations from a theme. For example, a theme preview may include a button that causes a device to play a sound when selected. However, in some implementations, a theme preview includes no sounds or other dynamic elements, and only includes visual aspects of a theme. A theme preview can include other GUI elements in addition to those of a preview image. For example, in addition to a preview image of a representative GUI, a theme preview can display interfaces including additional GUI elements that do not appear in the preview image. These may include icons, sounds, images, wallpapers, and the like. In some implementations, a theme preview includes multiple preview images showing previews of different GUIs.

The theme preview generation module arranges components of a GUI for a theme preview according to a template or another reference arrangement for GUI components. Templates for arranging components of a theme preview are stored in theme preview templates data storage 265. A template for a theme preview identifies components of a graphical user interface that are to be included in a theme preview and an arrangement for those components. For example, for a GUI including components for icons, a navigation bar and a status bar, a theme preview template may identify which icons are to be included in a theme preview, a location of the navigation bar in the theme preview and a location and height of the status bar in the theme preview. Thus, if a theme includes a GUI element of an icon for a dialer application, and a theme preview template includes a dialer icon component identifying a location and size for the dialer icon in a preview image, the theme preview generation module may generate a theme preview including the dialer icon at the location and having the size as specified in the theme preview template.

In some implementations, the theme preview generation module 220 generates a theme preview including components selected and arraigned based at least in part on components of a GUI being generated by a device. For example, rather than select and arrange components for a preview image according to a template, the theme preview generation module can select and arrange components according to components included in a home screen for an operating system of a device. In some implementations, the theme preview generation module 220 identifies an arraignment and selection of components of a GUI in a hierarchical database that stores configuration settings and options for an operating system or application. For example, a database may store locations in a GUI for icons and widgets of a launcher application. In some implementations, an arrangement and selection of components for a theme preview are identified in extensible markup language (XML) describing a layout for an application or operating system, and the theme customization module 230 can parse the XML layout to identify GUI components and an arrangement for the components.

A theme preview can be generated in real-time after a user requests to view a theme preview. The theme preview generation module 220 can also generate a theme preview prior to receiving a request by a user to view a theme preview. For example, the theme preview generation module can generate theme previews and store the theme previews in theme data storage 255, which the theme preview generation module can retrieve upon a user's request to view a theme preview. In some implementations, a theme preview includes an already-created preview image. For example, a theme preview may comprise a pre-rendered image representing a theme applied to a generic GUI, created by and received from a theme publisher.

In some implementations, a theme does not include a GUI element that is associated with a component of a GUI, and the theme preview generation module identifies an alternate GUI element to include in a theme preview. For example, a theme may not include an icon for a telephone application and a telephone icon component may be included in a theme preview template. In some implementations, the theme preview generation module associates a default alternate GUI element with the component. For example, a default telephone icon may be associated with the telephone icon component in the above example, and the theme preview generation module can apply the default GUI element to the component for the theme preview. In some implementations, if a theme does not include a GUI element for a component included in a theme preview, the theme preview generation component generates an interface for enabling a user to select a GUI element to add to the theme.

The theme customization module 230 modifies a theme based on user input, generating various interfaces for enabling a user to customize the theme. The interfaces show components of a GUI that can be modified and GUI elements of a theme associated with those components. A user can select to customize a component, and the theme customization module identifies and displays alternate GUI elements associated with the selected component. The user can select an alternate GUI element, which can be added to the theme and included in a theme preview and/or applied to a component of a GUI when the theme is applied to the GUI.

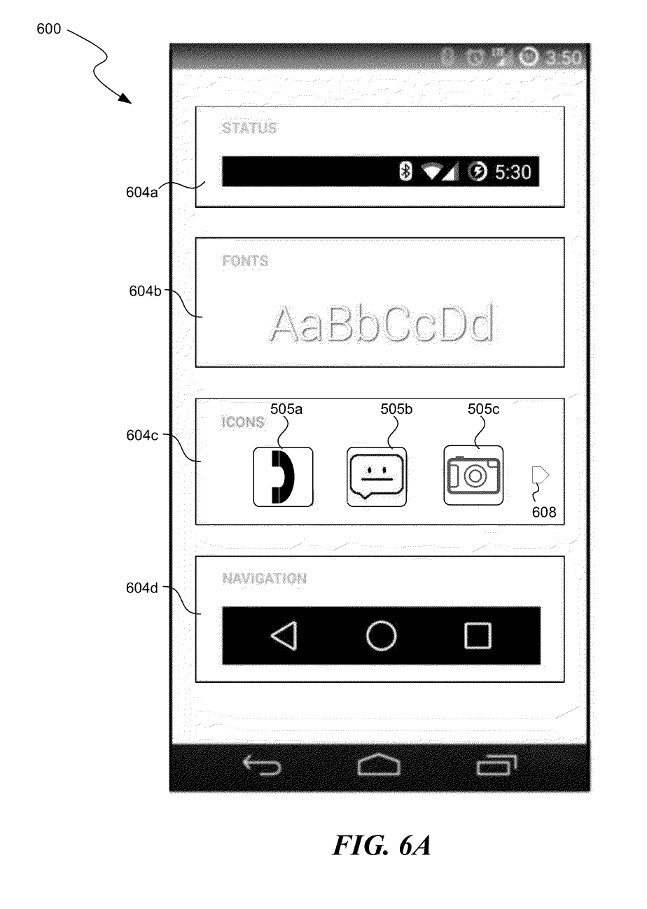

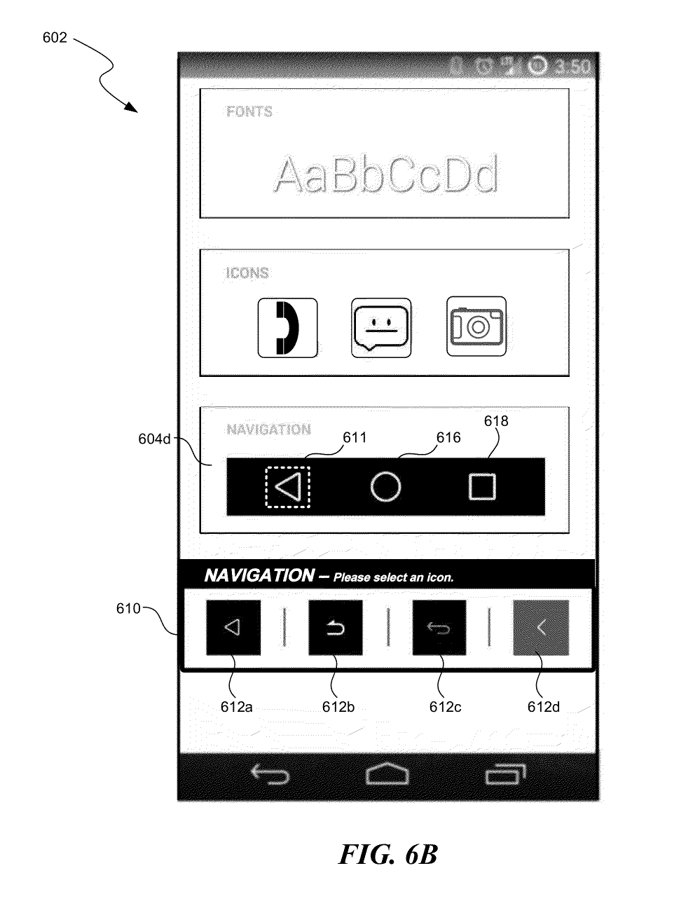

The theme customization module 230 identifies components of an interface to display for customization based on GUI component data, theme data, and/or GUI data stored in GUI details data storage 260. In some implementations, the theme customization module identifies and displays all components of a GUI that are customizable. For example, GUI data stored in GUI details data storage 260 may include a list of components of a GUI that can be modified by a theme, and the theme customization module can display all listed components in an interface for modifying the theme. If a theme being modified does not include a GUI element associated with a component of a GUI being customized, the system can associate a default GUI element with the component. In some implementations, the system displays an abbreviated listing of components that can be customized in a theme. For example, the theme customization module may identify only those components that a theme would modify if it were applied to a GUI. FIG. 6A shows an example interface displaying components of a GUI that can be customized.

Alternate GUI elements can be identified in theme data. Alternate GUI elements can be included in other themes, or they may be independent of a theme. The theme customization module receives a selection by a user of a component to customize and displays alternate GUI elements associated with the selected component. In some implementations, the theme customization module receives a selection of a GUI element associated with a component, and identifies GUI elements associated with the selected GUI element. For example, an icon for a messaging application can be shown in reference to an icons component. The system can receive a selection of the icon for the messaging application and identify alternate GUI elements corresponding to messaging icons.

The theme customization module can identify which GUI elements are associated with a component in a number of ways. In some implementations, GUI elements are associated with metadata identifying components of a GUI that they are associated with. For example, alternate GUI elements identified for a component being customized can be associated with the component in other themes. In some implementations, an alternate GUI element can be associated with a tag identifying a GUI component that it is associated with. The theme customization module 230 receives a selection by a user of an alternate GUI element and associates the selected GUI element with a component of a GUI being customized, creating a customized theme. FIG. 6B shows example interface displaying alternate GUI elements for receiving user input for customizing a theme. In some implementations, the theme preview generation module 220 automatically generates a theme preview of a customized theme.

In some implementations, the theme customization module 230 enables a user to create a new theme from scratch. The theme customization module can generate a customization interface displaying components of a GUI that are not associated with GUI elements, or that are associated with default GUI elements, such as GUI elements currently included in a GUI. The theme customization module can then receive user input identifying alternate GUI elements to include in the new theme. New and customized themes can be stored in the theme data storage area 255.

The theme application module 240 receives user input including an instruction to apply a theme, and outputs GUI customization data for modifying a GUI based on the theme. In some implementations, GUI customization data includes configuration details for an operating system or application, generated based on a theme being applied. GUI customization data can identify or include GUI elements of a theme, which an operating system or application can use for modifying settings associated with a GUI that theme is being applied to. For example, GUI customization data may include a command to modify settings for an operating system such that a particular sound file is included as a default ringtone. In some implementations, GUI customization data includes a resource table listing GUI elements of a theme and a command that an operating system reference the resource table for identifying GUI elements when generating a GUI. The operating system can traverse through multiple resource tables in order to identify GUI elements to apply to components of a GUI, and it can utilize framework and application resources for identifying GUI elements to apply to components not modified by the resource tables. Customization data can also include XML data identifying GUI elements for an operating system or application being themed. For example, XML data can identify a font to be applied as part of a theme to an operating system.

### Example Processes

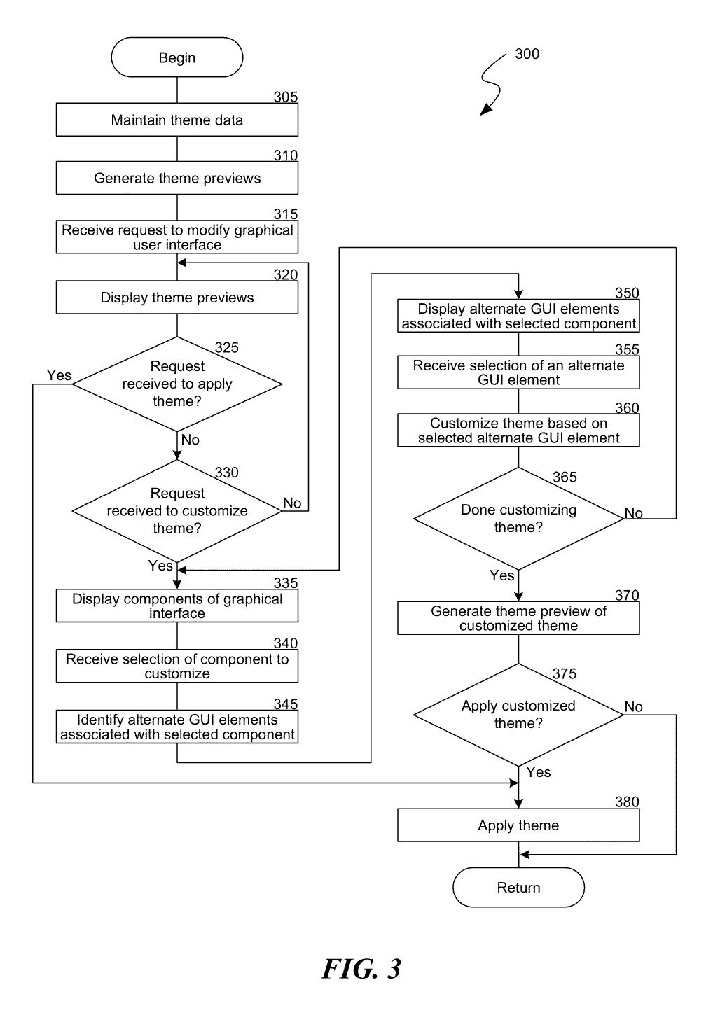

The system 200 for customizing a theme for modifying a look and feel of a GUI may operate on a mobile device. FIG. 3 is a flow diagram representing a process 300 performed by the system 200 for modifying a look and feel of a GUI generated by a mobile device. The GUI being modified can be generated by an operating system or an application. The process 300 can be performed as part of an initialization process for a device or an application. In some implementations, the process is performed for modifying a graphical user interface already being generated by a device.

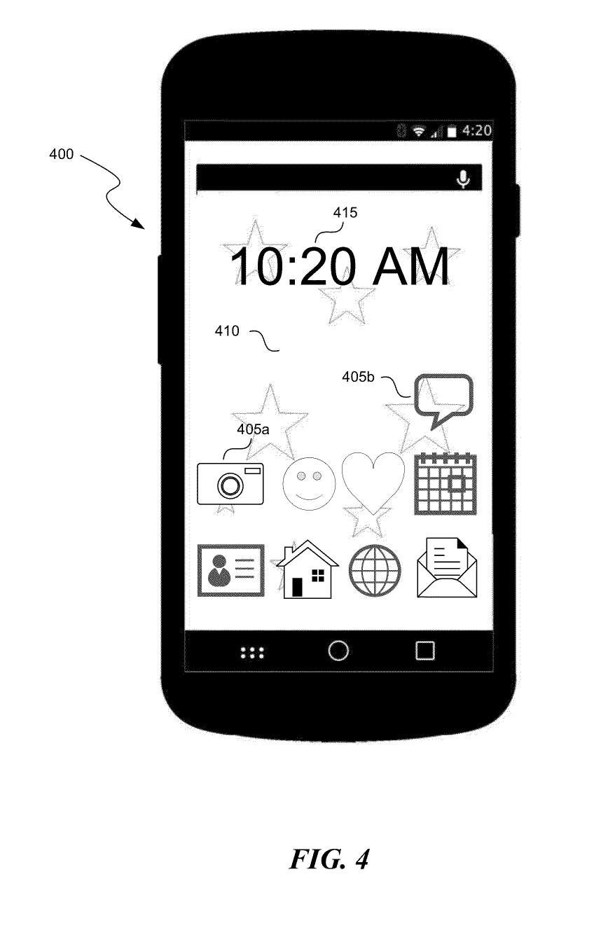

At a block 305, the system 200 maintains theme data, including themes, customized themes, and GUI elements. Themes may be maintained on the mobile device or in remote data storage. In some implementations, the system receives theme data that is maintained by another system. For example, theme data may be downloaded from a theme store operated by third party systems. FIG. 4 is a schematic drawing of a mobile device showing a representative GUI 400 of an operating system, which has been modified by a theme. GUI elements of the theme include icons 405a-b, a wallpaper image 410, and a clock 415. Furthermore, text in the GUI is in a font and color specified by the theme.

At a block 310, the system 200 generates theme previews. A theme preview comprises a preview image of a representative GUI showing GUI elements of a theme applied to components of the GUI. As discussed above, the system can generate a theme preview using a theme preview template. FIG. 5 shows a screenshot of a graphical user interface 500 including a representative theme preview 502. The theme preview 502 shows GUI elements of a theme, including theme icons 505, a theme wallpaper 510, a theme font 515, a theme status bar 520, and a theme navigation bar 525. The theme preview 502 includes a representative sample of GUI elements of the theme applied to components of a graphical user interface. For example, the theme preview includes GUI elements associated with applications common among mobile devices, including a dialer icon 505a, a messenger icon 505b, and a camera icon 505c, all arranged above the theme navigation bar 525.

A theme preview can also comprise other GUI elements not included in a preview image of a graphical user interface. For example, the system may show additional icons, images, and other visual GUI elements of a theme along with a preview image. The system can also display an interface enabling a user to preview sounds and/or animations associated with a theme. The system 200 can generate theme previews prior to a user requesting to modify a GUI. For example, the system may maintain a collection of theme previews for displaying after receiving a request from a user to do so. However, in some implementations, the system generates a theme preview in real-time after receiving a user's request to modify a GUI.

At a block 315, the system 200 receives a request by a user to modify a GUI. The request may be received via an application for customizing and applying a theme to a device. At a block 320, the system 200 generates an interface showing theme previews. Theme previews can be displayed in a variety of ways. In some implementations, the system displays theme previews individually, providing a mechanism for a user to traverse through the theme previews. The graphical user interface 500 of FIG. 5 displays the theme preview 502 adjacent to a first alternate theme preview 540, which is associated with an alternate theme, and a second alternate theme preview 545, which is associated with another alternate theme. A user of a device displaying the graphical user interface 500 can select either the first alternate theme preview 540 or the second alternate theme preview 545, and the system 200 can display the selected theme preview in the center of the graphical user interface 500, in the place of the theme preview 502.

At a decision block 325, the system 200 determines whether it has received an instruction by the user to apply a theme. In some implementations, the system determines that an instruction to apply a theme has been received when the system receives a gesture with respect to a theme preview associated with the theme, and the gesture corresponds to a selection to apply the theme. For example, the system may receive via a touchscreen an indication of a tap in reference to a theme preview, and determine that the tap corresponds to a gesture to apply a theme associated with the theme preview. If the system determines that it has received an instruction by the user to apply a theme, the process 300 proceeds to a block 380, and the system applies the theme.

If at decision block 325 the system determines that it has not received an instruction to apply a theme, the process 300 proceeds to a decision block 330, and the system 200 determines whether it has received an instruction to customize a theme. In some implementations, the system determines that an instruction to customize a theme has been received when the system receives a gesture with respect to a theme preview associated with a theme, and the gesture corresponds to a to a selection to customize the theme. For example, the system may receive via a touchscreen an indication of prolonged static contact in an area on which a theme preview is displayed, and determine that the contact corresponds to a gesture to customize a theme associated with the theme preview. In some implementations, an interface displaying a theme preview includes an icon or button that a user may select to customize a theme associated with the theme preview. For example, referring to FIG. 5, the theme preview 502 includes an edit button 530, which a user can select to customize the theme associated with the theme preview 502. If the system does not determine that an instruction has been received to customize a theme, the process 300 returns to block 320, and the system continues to display theme previews.

If at decision block 330 the system determines that it has received an instruction to customize a theme, the process proceeds to a block 335, and the system 200 generates an interface showing components of the graphical user interface that may be modified. FIG. 6A is a screenshot of an interface 600 showing representative components 604 of a GUI that a user may customize. These include a status bar component 604a, a font component 604b, an icons component 604c, and a navigation bar component 604d. The components 604 of the graphical user interface each include GUI elements, which correspond to GUI elements included in the theme being customized. Components of the GUI can include multiple sub-components. For example, the dialer icon 505a, the messenger icon 505b, and the camera icon 505c, which are included in the theme preview 502 for the theme, are grouped with the icons component 604c and are associated with a dialer icon component, messenger icon component, and camera icon component of a GUI, respectively. In some implementations, the system enables a user to view additional components or sub-components, including GUI elements associated with those components and sub-components, beyond those initially displayed by an interface. For example, the interface 600 includes an arrow 608, which a user may select to view additional icon sub-components and associated GUI elements of the icon component 604c.

At a block 340, the system 200 receives a selection by a user of a component displayed by the interface. The selection may include a gesture received via a touchscreen in reference to the component. For example, the system may receive an indication of a tap of a component, which it interprets as a selection of the component. In some implementations, the system receives a selection of a sub-component or a particular GUI element associated with a component or sub-component. For example, the system may receive a selection by a user of the dialer icon 505a. The system may interpret a selection of a GUI element of a component as an instruction to customize the component or sub-component associated with that particular GUI element.

At a block 345, the system 200 identifies alternate GUI elements associated with the selected component. Alternate GUI elements are identified in theme data accessible to the system. For example, the system may identify alternate GUI elements in themes stored locally on a device or available via a theme store. In some implementations, the system identifies alternate GUI elements that are not associated with any theme. For example, if the system receives a selection of a wallpaper component, the system may identify alternate GUI elements including all image files having a resolution greater than a predetermined size that are stored on a device.

The system may determine which GUI elements are associated with a selected component or GUI element in a variety of ways. In some implementations, the system compares a selected component or GUI element with metadata associated with identified GUI elements. For example, tags associated with a GUI element may identify one or more components. Tags can also identify a GUI element type or another identifier that links GUI elements to components or other GUI elements. In some implementations, the system identifies GUI elements associated with a selected component or GUI element based on identified GUI elements sharing a tag associated with the selected component or GUI element. For example, if a user's selection of a status bar component comprises a selection of a GUI element corresponding to a battery meter, the system may identify GUI elements associated with tags for a battery meter and a status bar.

At a block 350, the system 200 generates an interface showing alternate GUI elements identified as being associated with the selected component. FIG. 6B is a screenshot of an interface 602 for displaying GUI elements associated with a selected component. A user has selected the navigation component 604d, and more specifically, a back icon GUI element 611 associated with a back icon sub-component. The interface includes a window 610 displaying GUI elements 612 identified as being associated with the back icon GUI element 611 of the navigation component 604d.

At a block 355, the system 200 receives a selection by a user of an alternate GUI element associated with the selected component. For example, the system may receive an indication of a tap on a touchscreen device in reference to a displayed alternate GUI element. At a block 360, the system customizes the theme based on the selected alternate GUI element. To customize the theme, the system may replace a GUI element previously included in a theme with the selected alternate GUI element. In some implementations, an alternate GUI element selected by a user is associated with other GUI elements, and, in addition to customizing a theme with the selected alternate GUI element, the system customizes the theme with the other GUI elements. For example, referring to FIG. 6B, a selection may be received of icon GUI element 612b, and the system may identify and incorporate related icons that are in a similar style as the selected icon GUI element 612b. These related icons may replace a home icon GUI element 616 and a menu icon GUI element 618, respectively, of the navigation bar component 608.

At a decision block 365, the system 200 determines whether a user has completed customizing the theme. In some implementations, the system determines that the user has completed customizing a theme when it receives a selection by the user of an option to cease customizing the theme. The system may also determine that the user has completed customizing the theme if the user selects to view a theme preview, or if the user selects to apply the customized theme. In some implementations, the system determines that the user has not completed customizing the theme if the system determines that the user has continued viewing components for customizing. If the system determines that the user has not completed customizing the theme, the process 300 returns to block 335, and the system displays components of the graphical user interface.

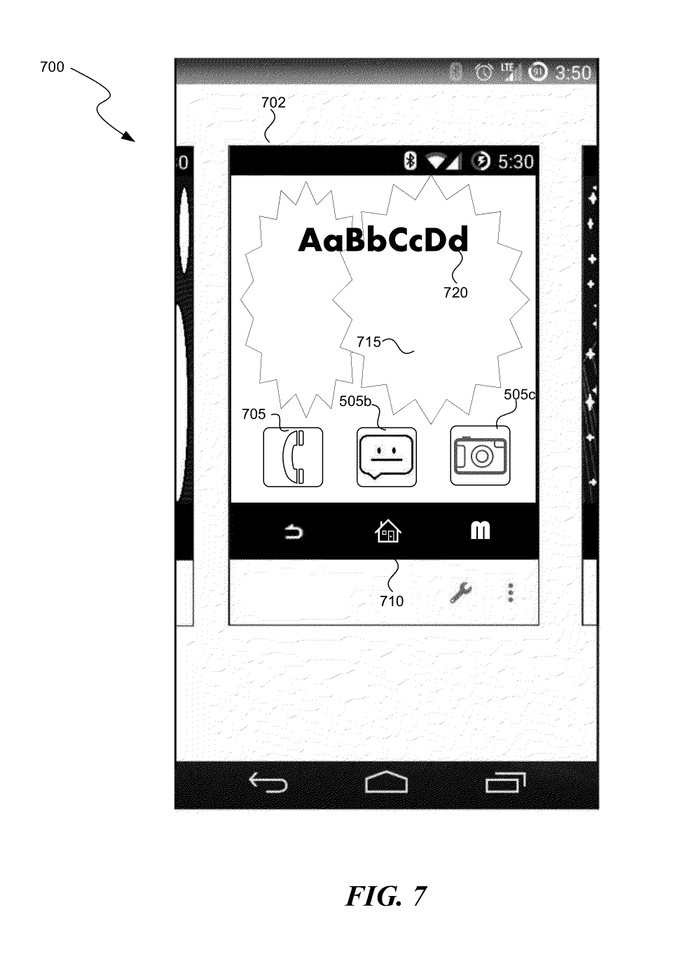

If at a decision block 365, the system determines that the user has completed customizing the theme, the process 300 proceeds to a block 370, and the system 200 generates a theme preview for the customized theme. The system generates the theme preview based at least in part on theme data for the customized theme. The system can generate a theme preview in the ways discussed above with respect to the theme previews discussed with reference to block 310. For example, the system may apply GUI elements for the customized theme to components of the graphical user interface arranged in a default arrangement according to a theme preview template. The GUI elements of the theme preview include the GUI elements of the theme being customized that were not replaced by the user and GUI elements added by the user. FIG. 7 shows a screenshot of a graphical user interface 700 including a representative theme preview 702 of a customized theme. The customized theme represents a customized version of the theme described with respect to the theme preview 502 of FIG. 5. The theme preview 702 shows GUI elements of the original theme and GUI elements selected by the user in modifying the theme. New GUI elements include a theme telephone icon 705, a theme navigation bar 710, a theme wallpaper 715, and a theme font 720. GUI elements remaining from the original theme include the theme messaging icon 505b and theme camera icon 505c.

At a block 375, the system 200 determines whether to apply the customized theme to the graphical user interface. In some implementations, the system determines to apply the customized theme when it receives a predetermined gesture by the user in relation to a theme preview of the customized theme. The system can determine to apply the customized theme after receiving a selection by a user of an option to apply the customized theme. In some implementations, rather than generating a theme preview of a customized theme, the system determines to apply a customized theme prior to generating the theme preview. For example, the system may apply a customized theme at the request of a user after the user has ceased customizing the theme. The system may determine to not apply the customized theme if the user selects to save a customized theme and not apply the theme. The system may determine to not apply the customized theme if the user selects to save a customized theme and to not apply the theme to the graphical user interface. If the system determines to not apply the customized theme, the process 300 returns.

If the system does determine to apply the customized theme, the process proceeds to a block 380, and the system applies the customized theme. The system can apply a customized theme as it would an unmodified theme. For example, the system may apply GUI elements of the customized theme, including those selected by a user, to components of the GUI that they are associated with, modifying configuration settings for the GUI. In some implementations, the system applies a GUI element of a theme to a component of a GUI by deleting a reference in settings for the GUI from a previously-referenced GUI element and adding a reference to the GUI element of the customized theme.

The disclosed system and method enable a user to easily customize a GUI for an operating system or application. The system enables a user to modify a theme for the GUI. The user can preview how a customized theme may alter the look and feel of the GUI prior to applying the customized theme to the GUI.

### Conclusion

Those skilled in the art will appreciate that the actual implementation of a data storage area may take a variety of forms, and the phrase “data storage area” is used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/we claim:

1. A method for customizing a look and feel of a graphical user interface (GUI) displayed by a device, the method performed by a computing system having a processor and a memory, the method comprising:
maintaining packages of GUI elements for modifying a look and feel of a GUI if applied to the GUI;
generating a first preview of a first package of GUI elements applied to the GUI,
wherein the GUI includes a customizable component,
wherein the first package of GUI elements includes a GUI element that is associated with the customizable component of the GUI, and
wherein the first preview of the first package includes the GUI element that is associated with the component of the GUI applied to the component of the GUI;
receiving a request from a user to modify a look and feel of the GUI;
displaying, via a display device, the first preview of the first package of GUI elements applied to the GUI;
receiving a request from the user to customize the package of GUI elements;
displaying, via the display device, the customizable component of the graphical user interface and the GUI element of the first package associated with the customizable component of the GUI;
receiving a request from the user to replace the GUI element of the first package with another GUI element;
identifying a second GUI element in a second package of GUI elements;
displaying, via the display device, the second GUI element of the second package;
receiving an indication from the user to customize the first package by replacing the GUI element of the first package with the GUI element of the second package;
receiving an indication from the user to apply to the GUI the customized first package including the GUI element of the second package; and
applying to the GUI the customized first package of GUI elements including the GUI element of the second package.

2. The method of claim 1, further comprising:
generating a preview of the customized first package of GUI elements applied to the GUI,
wherein the preview of the customized first package includes the GUI element of the second package applied to the customized component of the GUI.

3. A tangible computer-readable storage medium containing instructions for causing a mobile device to perform a method for modifying a look and feel of a graphical user interface (GUI), the method comprising:
receiving a request by a user to modify a look and feel of a GUI displayed by the mobile device,
wherein the GUI includes a customizable component;
displaying a theme preview of a first theme,
wherein the first theme includes a first GUI element, and
wherein the theme preview includes the first GUI element applied to the customizable component of the GUI,
receiving a request to customize the first theme;
identifying a second GUI element;
receiving an instruction from a user to customize the first theme by associating the second GUI element with the customizable component;
receiving an instruction from the user to apply the customized first theme to the GUI; and
applying the customized first theme to the GUI, wherein the second GUI element is applied to the customizable component.

4. The tangible computer-readable storage medium of claim 3, wherein the theme preview is a first theme preview, and the method further comprises:
generating a second theme preview using the customized first theme,
wherein the second theme preview includes the second GUI element applied to the customizable component.

5. The tangible computer-readable storage medium of claim 4, wherein the method further comprises:
identifying an arrangement for components of a GUI in a first theme preview; and
generating the first theme preview using the first theme,
wherein the customizable component is arranged in the first theme preview according to the identified arrangement for components of the GUI; and
wherein the first theme preview includes the first GUI element applied to the customizable component.

6. The tangible computer-readable storage medium of claim 4, further comprising:
upon receiving the request to customize the theme:
generating an interface showing the customizable component of the GUI;
receiving a request from the user to customize the customizable component; and
generating an interface showing the second GUI element,
wherein the second GUI element is associated with the customizable component of the GUI.

7. The tangible computer-readable storage medium of claim 4, wherein the first GUI element includes an icon, a navigation bar, a status bar, a wallpaper, a font, or an audio clip.

8. The tangible computer-readable storage medium of claim 4, wherein identifying a second GUI element includes identifying the second GUI element in a second theme.

9. The tangible computer-readable storage medium of claim 5, wherein the arrangement for components of the GUI in the first theme is determined based at least in part on a current arrangement of components in the GUI.

10. The tangible computer-readable storage medium of claim 6, wherein identifying a second GUI element includes identifying the second GUI element in a second theme, and wherein the method further comprises:
identifying a third GUI element in a third theme,
wherein the third GUI element is associated with the customizable component of the GUI, and
wherein the interface showing the second GUI element shows the third GUI element.

11. The tangible computer-readable storage medium of claim 6, wherein the method further comprises:
identifying a second customizable component of the GUI,
wherein the first theme includes a third GUI element, and
wherein the first theme includes an association between the third GUI element and the second customizable component;
identifying a fourth GUI element in a second theme; and
receiving an instruction from the user to customize the customized first theme by associating the fourth GUI element with the second customizable component,
wherein the fourth GUI element is applied to the second customizable component when the customized first theme is applied to the GUI.

12. A method for modifying a look and feel of a graphical user interface (GUI), the method performed by a computing system that includes a processor and a memory, the method comprising:
receiving a request by a user to modify a look and feel of a GUI displayed by the mobile device,
wherein the GUI includes a customizable component;
displaying a theme preview of a first theme,
wherein the first theme includes a first GUI element, and
wherein the theme preview includes the first GUI element applied to the customizable component of the GUI,
receiving a request to customize the first theme;
identifying a second GUI element;
receiving an instruction from a user to customize the first theme by associating the second GUI element with the customizable component;
receiving an instruction from the user to apply the customized first theme to the GUI; and
applying the customized first theme to the GUI,
wherein the second GUI element is applied to the customizable component.

13. The method of claim 12, wherein the theme preview is a first theme preview, and the method further comprises:
generating a second theme preview using the customized first theme,
wherein the second theme preview includes the second GUI element applied to the customizable component.

14. The method of claim 13, wherein the method further comprises:
identifying an arrangement for components of a GUI in a first theme preview; and
generating the first theme preview using the first theme,
wherein the customizable component is arranged in the first theme preview according to the identified arrangement for components of the GUI; and
wherein the first theme preview includes the first GUI element applied to the customizable component.

15. The method of claim 13, further comprising:
upon receiving the request to customize the theme:
generating an interface showing the customizable component of the GUI;
receiving a request from the user to customize the customizable component; and
generating an interface showing the second GUI element,
wherein the second GUI element is associated with the customizable component of the GUI.

16. The method of claim 13, wherein the first GUI element includes an icon, a navigation bar, a status bar, a wallpaper, a font, or an audio clip.

17. The method of claim 13, wherein identifying a second GUI element includes identifying the second GUI element in a second theme.

18. The method of claim 14, wherein the arrangement for components of the GUI in the first theme is determined based at least in part on a current arrangement of components in the GUI.

19. The method of claim 15, wherein identifying a second GUI element includes identifying the second GUI element in a second theme, and wherein the method further comprises:
identifying a third GUI element in a third theme,
wherein the third GUI element is associated with the customizable component of the GUI, and
wherein the interface showing the second GUI element shows the third GUI element.

20. The method of claim 15, wherein the method further comprises:
identifying a second customizable component of the GUI,
wherein the first theme includes a third GUI element, and
wherein the first theme includes an association between the third GUI element and the second customizable component;
identifying a fourth GUI element in a second theme; and
receiving an instruction from the user to customize the customized first theme by associating the fourth GUI element with the second customizable component,
wherein the fourth GUI element is applied to the second customizable component when the customized first theme is applied to the GUI.
